(19) United States
(12) Patent Application Publication
(10) Pub. No.: US 2026/0197395 A1
(43) Pub. Date: Jul. 9, 2026

(54) COLLISION NOTIFICATION METHOD AND COLLISION NOTIFICATION DEVICE

(71) Applicant: ASUSTEK COMPUTER INC., TAIPEI (TW)

(72) Inventors: Jia-Jung KUO, TAIPEI (TW); Chih-Hsien YANG, TAIPEI (TW)

(21) Appl. No.: 19/098,456

(22) Filed: Apr. 2, 2025

(30) Foreign Application Priority Data
Jan. 9, 2025 (TW) 114100930

(51) Int. Cl. H04M 1/72454

(52) U.S. Cl. CPC H04M 1/72454; H04M 2250/12

(57) ABSTRACT

A collision notification method is provided and applicable to a mobile device. The mobile device includes an acceleration sensor, a sound sensor, and a display. Firstly, it is determined based on acceleration data whether the mobile device is in a falling state. After it is determined that the mobile device is in the falling state, collection of environmental sound data is started. Subsequently, it is determined based on the acceleration data whether the mobile device has collided. After it is determined that the mobile device has collided, calculation of a predetermined time is started, and the collection of the environmental sound data is stopped after the predetermined time. Next, a collision severity of the mobile device is determined based on the acceleration data and the collected environmental sound data. Subsequently, a notification signal is generated based on the collision severity. A collision notification device is also provided.

### CROSS-REFERENCE TO RELATED APPLICATION

This application claims the priority benefit of Taiwan Application Serial No. 114100930, filed on Jan. 9, 2025. The entirety of the above-mentioned patent application is hereby incorporated by reference herein and made a part of specification.

### BACKGROUND OF THE INVENTION

### Field of the Invention

The disclosure relates to the technical field of mobile devices, and in particular, to a collision notification method for a mobile device and a collision notification device.

### Description of the Related Art

Mobile devices possess anti-collision and anti-vibration functions to a certain extent nowadays. However, currently, mobile devices on the market do not provide any feedback mechanism for physical collisions. Users do not perform accurate risk assessment for impact.

Secondly, once a mobile device collides nowadays, a user only visually inspects hardware appearance to determine whether there is any obvious damage, and does not accurately determine a collision severity.

### BRIEF SUMMARY OF THE INVENTION

The disclosure provides a collision notification method, applicable to a mobile device. The mobile device includes an acceleration sensor, a sound sensor, and a display. The acceleration sensor is adapted to obtain acceleration data corresponding to the mobile device. The sound sensor is adapted to obtain environmental sound data. The collision notification method includes the following steps. Firstly, it is determined based on acceleration data whether the mobile device is in a falling state. After it is determined that the mobile device is in the falling state, collection of environmental sound data is started. Subsequently, it is determined based on the acceleration data whether the mobile device has collided. After it is determined that the mobile device has collided, calculation of a predetermined time is started, and the collection of the environmental sound data is stopped after the predetermined time. Next, a collision severity of the mobile device is determined based on the acceleration data and the collected environmental sound data. Subsequently, a notification signal is generated based on the collision severity.

The disclosure also provides a collision notification device, applicable to a mobile device. The mobile device includes a display. The collision notification device includes an acceleration sensor, a sound sensor, a falling determination unit, a collision determination unit, a sound data collection unit, a collision data processing unit, and a collision notification generation unit. The acceleration sensor is adapted to obtain acceleration data corresponding to the mobile device. The sound sensor is adapted to obtain environmental sound data. The falling determination unit is adapted to determine, based on the acceleration data, whether the mobile device is in a falling state. The collision determination unit is adapted to determine, based on the acceleration data, whether the mobile device has collided. The sound data collection unit is adapted to start collection of the environmental sound data through the sound sensor after determining that the mobile device is in the falling state, start calculation of a predetermined time after determining that the mobile device has collided, and stop the collection of the environmental sound data after the predetermined time. The collision data processing unit is adapted to determine a collision severity of the mobile device based on the acceleration data and the collected environmental sound data. The collision notification generation unit is adapted to generate a notification signal based on the collision severity.

The memory stability adjustment program of a conventional computer product is very cumbersome and time-consuming, and a user further needs to record parameter settings at his/her discretion, which is inconvenient for execution. In comparison, through the collision notification method and the collision notification device provided in the disclosure, a basic input/output system is allowed to effectively find an updated parameter set superior to the original parameter set, so as to facilitate improvement in memory stability and an increase in an overclocking amplitude.

### BRIEF DESCRIPTION OF THE DRAWINGS

FIG. 1 is a schematic diagram of a collision notification device according to an embodiment of the disclosure;

FIG. 2 is a schematic diagram of a collision notification method according to an embodiment of the disclosure;

FIG. 3 shows a first embodiment of step S250 in FIG. 2;

FIG. 4 shows a second embodiment of step S250 in FIG. 2;

FIG. 5 shows a third embodiment of step S250 in FIG. 2;

FIG. 6 is a schematic diagram of a collision notification device according to another embodiment of the disclosure; and

FIG. 7 is a flowchart of a collision notification method according to another embodiment of the disclosure.

### DETAILED DESCRIPTION OF THE EMBODIMENTS

Specific embodiments of the disclosure are described in more details below with reference to the schematic diagrams. Advantages and features of the disclosure are to be clearer based on the following descriptions and claims. It is to be noted that all figures are in a very simple form and in an inaccurate proportion, and are merely intended to assist in convenient and clear description of the embodiments of the disclosure.

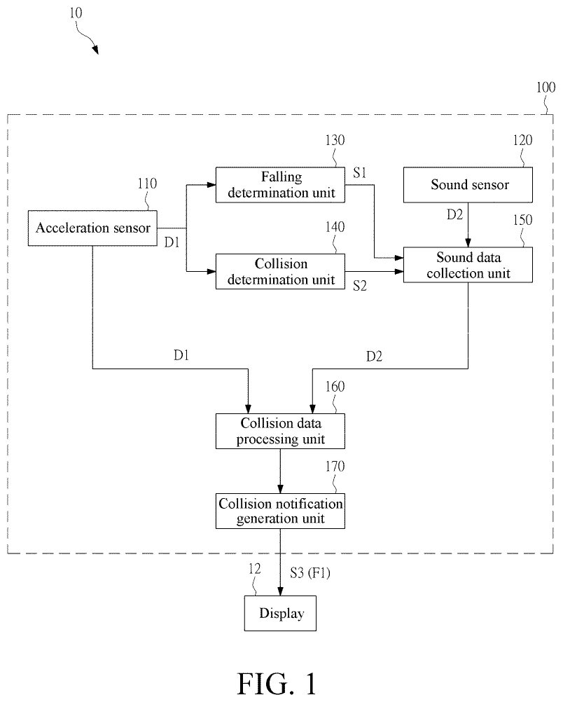

FIG. 1 is a schematic diagram of a collision notification device 100 according to an embodiment of the disclosure.

The collision notification device 100 of the disclosure is applicable to a mobile device 10. The mobile device 10 includes a display 12.

The collision notification device 100 includes an acceleration sensor 110, a sound sensor 120, a falling determination unit 130, a collision determination unit 140, a sound data collection unit 150, a collision data processing unit 160, and a collision notification generation unit 170.

The acceleration sensor 110 is adapted to obtain acceleration data D1 corresponding to the mobile device 10. The sound sensor 120 is adapted to obtain environmental sound data D2.

The falling determination unit 130 is adapted to determine, based on the acceleration data D1, whether the mobile device 10 is in a falling state. The collision determination unit 140 is adapted to determine, based on the acceleration data D1, whether the mobile device 10 has collided. The technology of determining, through the acceleration data D1, whether the mobile device 10 falls or collides is known in the art, and is not the focus of the disclosure. Therefore, details are not described herein.

The sound data collection unit 150 is adapted to start collection of the environmental sound data D2 through the sound sensor 120 after determining that the mobile device 10 is in the falling state, start calculation of a predetermined time after determining that the mobile device 10 has collided, and stop the collection of the environmental sound data D2 after the predetermined time. Specifically, when determining that the mobile device 10 is in a falling state, the falling determination unit 130 generates a recording start signal S1 and transmits the recording start signal to the sound data collection unit 150, to notify the sound data collection unit to start the collection of the environmental sound data D2. When determining that the mobile device 10 has collided, the collision determination unit 140 generates a recording stop signal S2 and transmits the recording stop signal to the sound data collection unit 150, to notify the sound data collection unit 150 to start calculation of a default time.

The collision data processing unit 160 is adapted to determine a collision severity of the mobile device 10 based on the acceleration data D1 and the collected environmental sound data D2. In an embodiment, the collision data processing unit 160 determines, based on the acceleration data D1, a speed and a collision orientation of the mobile device 10 during the collision, and determines the collision severity of the mobile device 10 as a whole and a risk of damage to the mobile device 10 based on a collision sound volume collected from the environmental sound data D2. Furthermore, if the mobile device 10 is at a higher speed and generates a louder collision sound during the collision, there is a higher possibility that a serious collision occurs.

The collision notification generation unit 170 is adapted to generate a notification signal S3 based on the collision severity. In an embodiment, the collision notification generation unit 170 is adapted to generate a collision notification image F1 presented on the display 12 based on the collision severity. However, the disclosure is not limited thereto. In an embodiment, the notification signal S3 is also a sound signal, a light signal, or a vibration signal. The collision notification image F1 is a virtual collision damage image for notifying a user of the collision severity.

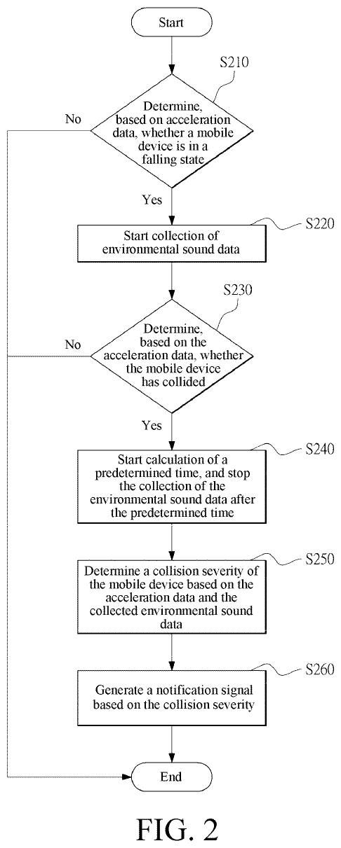

FIG. 2 is a schematic diagram of a collision notification method according to an embodiment of the disclosure. The collision notification method is applicable to the mobile device 10 in FIG. 1.

As shown in the figure, the collision notification method includes the following steps.

Firstly, as described in a determining step S210, it is determined based on acceleration data D1 whether a mobile device 10 is in a falling state. If it is determined that the mobile device 10 is not in the falling state, this process ends.

If it is determined that the mobile device 10 is in the falling state, this process proceeds to step S220, and collection of environmental sound data D2 is started.

Carrying on with step S220, after it is determined that the mobile device 10 is in the falling state, as described in a determining step S230, it is determined based on the acceleration data D1 whether the mobile device 10 has collided.

After it is determined that the mobile device 10 has collided, this process proceeds to step S240, calculation of a predetermined time is started, and the collection of the environmental sound data D2 is stopped after the predetermined time. If it is determined that the mobile device 10 has not collided, this process ends.

Carrying on with step S240, next, as described in step S250, a collision severity of the mobile device 10 is determined based on the acceleration data D1 and the collected environmental sound data D2.

Subsequently, as described in step S260, a notification signal S3 is generated based on the collision severity.

In an embodiment, the foregoing step of generating the notification signal S3 based on the collision severity is generating a collision notification image F1 presented on the display 12 based on the collision severity. However, the disclosure is not limited thereto. In an embodiment, the notification signal S3 is also a sound signal, a light signal, or a vibration signal.

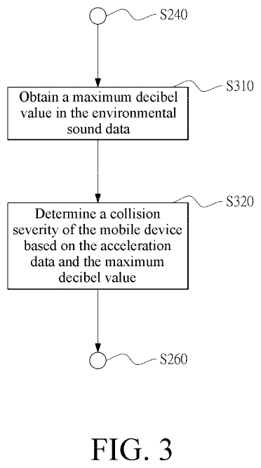

Refer to FIG. 3 together. FIG. 3 shows a first embodiment of step S250 in FIG. 2.

Carrying on with step S240, firstly, as described in step S310, a maximum decibel value in the collected environmental sound data D2 is obtained.

Next, as described in step S320, a collision severity of the mobile device 10 is determined based on the acceleration data D1 and the maximum decibel value.

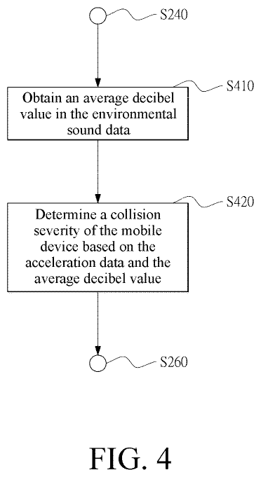

Refer to FIG. 4 together. FIG. 4 shows a second embodiment of step S250 in FIG. 2.

Carrying on with step S240, firstly, as described in step S410, an average decibel value in the collected environmental sound data D2 is obtained.

Next, as described in step S420, the collision severity of the mobile device 10 is determined based on the acceleration data D1 and the average decibel value.

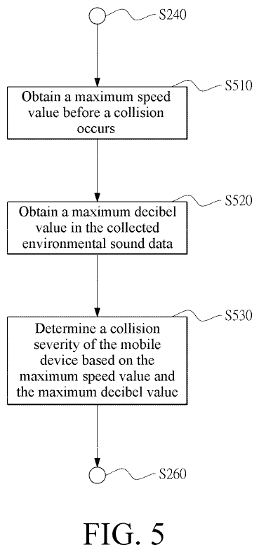

Refer to FIG. 5 together. FIG. 5 shows a third embodiment of step S250 in FIG. 2.

Carrying on with step S240, firstly, as described in step S510, a maximum speed value before a collision occurs is obtained.

Next, as described in step S520, a maximum decibel value in the collected environmental sound data D2 is obtained.

Then, as described in step S530, a collision severity of the mobile device 10 is determined based on the maximum speed value and the maximum decibel value.

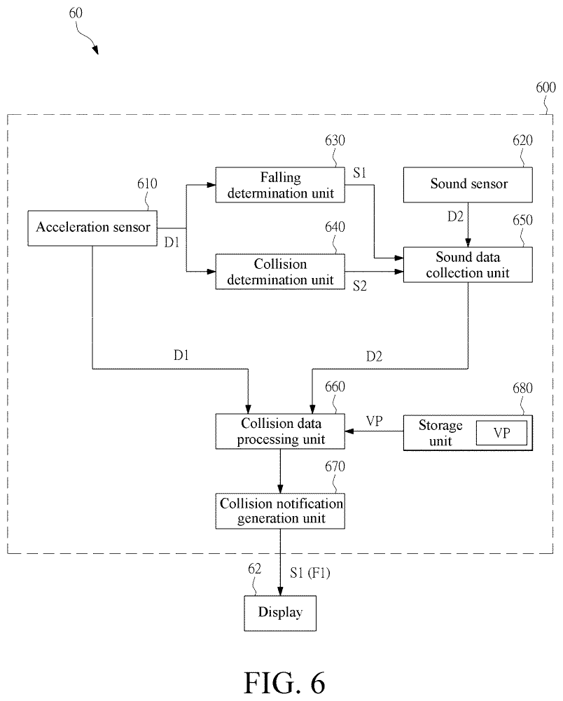

FIG. 6 is a schematic diagram of a collision notification device 600 according to another embodiment of the disclosure.

The collision notification device 600 of the disclosure is applicable to a mobile device 60. The mobile device 60 includes a display 62.

The collision notification device 600 includes an acceleration sensor 610, a sound sensor 620, a falling determination unit 630, a collision determination unit 640, a sound data collection unit 650, a collision data processing unit 660, a collision notification generation unit 670, and a storage unit 680.

The acceleration sensor 610 is adapted to obtain acceleration data D1 corresponding to the mobile device 60. The sound sensor 620 is adapted to obtain environmental sound data D2.

The falling determination unit 630 is adapted to determine, based on the acceleration data D1, whether the mobile device 60 is in a falling state.

The collision determination unit 640 is adapted to determine, based on the acceleration data D1, whether the mobile device 60 has collided.

The sound data collection unit 650 is adapted to start collection of the environmental sound data D2 through the sound sensor 620 after determining that the mobile device 60 is in the falling state, start calculation of a predetermined time after determining that the mobile device 60 has collided, and stop the collection of the environmental sound data D2 after the predetermined time.

The storage unit 680 is adapted to store a plurality of collision voiceprints VPs. T the plurality of collision voiceprints VPs respectively corresponds to a plurality of default collision objects.

The collision data processing unit 660 is adapted to obtain the plurality of collision voiceprints VPs, and compare the environmental sound data D2 with the plurality of collision voiceprints VPs, to infer an actual collision object of the mobile device 60.

The collision data processing unit 660 is also adapted to obtain a maximum decibel value in the environmental sound data D2. The collision data processing unit 660 is configured to determine a collision severity of the mobile device 60 based on the acceleration data D1, the actual collision object inferred through comparison of the collision voiceprints VPs, and the maximum decibel value.

In an embodiment, if the maximum decibel value in the environmental sound data D2 is rather large, a maximum speed value presented in the acceleration data D1 is rather large. Alternatively, when the actual collision object inferred through comparison of the collision voiceprints VPs is a hard object such as metal, there is a higher possibility that a serious collision occurs.

The collision notification generation unit 670 is adapted to generate a notification signal S3 based on the collision severity. In an embodiment, the collision notification generation unit 670 is adapted to generate a collision notification image F1 presented on the display 62 based on the collision severity. However, the disclosure is not limited thereto.

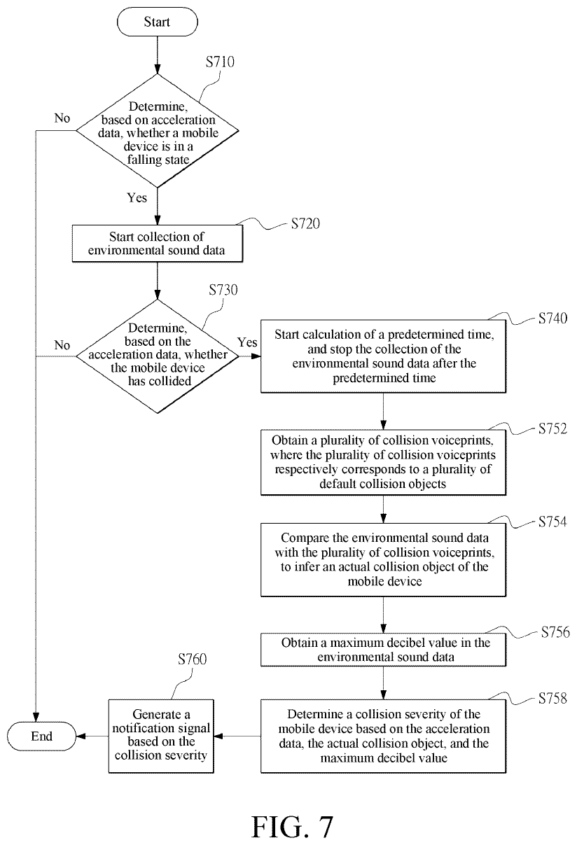

FIG. 7 is a flowchart of a collision notification method according to another embodiment of the disclosure. The collision notification method is applicable to the mobile device 60 in FIG. 6.

Firstly, as described in a determining step S710, it is determined based on acceleration data D1 whether a mobile device 60 is in a falling state. If it is determined that the mobile device 60 is not in the falling state, this process ends.

If it is determined that the mobile device 60 is in the falling state, this process proceeds to step S720, and collection of environmental sound data D2 is started.

Carrying on with step S720, after it is determined that the mobile device 60 is in the falling state, as described in a determining step S730, it is determined based on the acceleration data D1 whether the mobile device 60 has collided.

After it is determined that the mobile device 60 has collided, this process proceeds to step S740, calculation of a predetermined time is started, and the collection of the environmental sound data D2 is stopped after the predetermined time. If it is determined that the mobile device 60 has not collided, this process ends.

Carrying on with step S740, next, as described in step S752, a plurality of collision voiceprints VPs is obtained. The plurality of collision voiceprints VPs respectively corresponds to a plurality of default collision objects.

Subsequently, as described in step S754, the environmental sound data D2 is compared with the plurality of collision voiceprints VPs, to infer an actual collision object of the mobile device 60.

Then, as described in step S756, a maximum decibel value in the environmental sound data D2 is obtained.

Next, as described in step S758, a collision severity of the mobile device 60 is determined based on the acceleration data D1, the actual collision object, and the maximum decibel value.

Subsequently, as described in step S760, a notification signal S3 is generated based on the collision severity.

In an embodiment, the foregoing step of generating the notification signal S3 based on the collision severity is generating a collision notification image F1 presented on the display 62 based on the collision severity. However, the disclosure is not limited thereto. In an embodiment, the notification signal S3 is also a sound signal, a light signal, or a vibration signal.

The above descriptions are merely preferred embodiments of the disclosure, and do not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

What is claimed is:

1. A collision notification method, applicable to a mobile device, wherein the mobile device comprises an acceleration sensor, a sound sensor, and a display, the acceleration sensor is adapted to obtain acceleration data corresponding to the mobile device, the sound sensor is adapted to obtain environmental sound data, and the collision notification method comprises:
determining, based on the acceleration data, whether the mobile device is in a falling state;
starting collection of the environmental sound data after determining that the mobile device is in the falling state;
determining, based on the acceleration data, whether the mobile device has collided;
starting calculation of a predetermined time after determining that the mobile device has collided, and stopping the collection of the environmental sound data after the predetermined time;
determining a collision severity of the mobile device based on the acceleration data and the collected environmental sound data; and
generating a notification signal based on the collision severity.

2. The collision notification method according to claim 1, wherein the step of determining the collision severity of the mobile device based on the acceleration data and the collected environmental sound data comprises:
obtaining a maximum decibel value in the environmental sound data; and
determining the collision severity of the mobile device based on the acceleration data and the maximum decibel value.

3. The collision notification method according to claim 1, wherein the step of determining the collision severity of the mobile device based on the acceleration data and the collected environmental sound data comprises:
obtaining an average decibel value in the environmental sound data; and
determining the collision severity of the mobile device based on the acceleration data and the average decibel value.

4. The collision notification method according to claim 1, wherein the step of determining the collision severity of the mobile device based on the acceleration data and the collected environmental sound data comprises:
obtaining a maximum speed value before a collision occurs;
obtaining a maximum decibel value in the environmental sound data; and
determining the collision severity of the mobile device based on the maximum speed value and the maximum decibel value.

5. The collision notification method according to claim 1, wherein the step of determining the collision severity of the mobile device based on the acceleration data and the collected environmental sound data comprises:
obtaining a plurality of collision voiceprints, wherein the plurality of collision voiceprints respectively corresponds to a plurality of default collision objects;
comparing the environmental sound data with the plurality of collision voiceprints, to infer an actual collision object of the mobile device;
obtaining a maximum decibel value in the environmental sound data; and
determining the collision severity of the mobile device based on the acceleration data, the actual collision object, and the maximum decibel value.

6. The collision notification method according to claim 1, wherein the step of generating the notification signal based on the collision severity is generating a collision notification image presented on the display based on the collision severity.

7. A collision notification device, applicable to a mobile device, wherein the mobile device comprises a display, and the collision notification device comprises:
an acceleration sensor, adapted to obtain acceleration data corresponding to the mobile device;
a sound sensor, adapted to obtain environmental sound data;
a falling determination unit, adapted to determine, based on the acceleration data, whether the mobile device is in a falling state;
a collision determination unit, adapted to determine, based on the acceleration data, whether the mobile device has collided;
a sound data collection unit, adapted to notify the sound sensor to start collection of the environmental sound data after determining that the mobile device is in the falling state, to start calculation of a predetermined time after determining that the mobile device has collided, and to stop the collection of the environmental sound data after the predetermined time;
a collision data processing unit, adapted to determine a collision severity of the mobile device based on the acceleration data and the collected environmental sound data; and
a collision notification generation unit, adapted to generate a notification signal based on the collision severity.

8. The collision notification device according to claim 7, wherein the collision data processing unit obtains a maximum decibel value in the environmental sound data, and determines the collision severity of the mobile device based on the acceleration data and the maximum decibel value.

9. The collision notification device according to claim 7, wherein the collision data processing unit obtains an average decibel value in the environmental sound data, and determines the collision severity of the mobile device based on the acceleration data and the average decibel value.

10. The collision notification device according to claim 7, wherein the collision data processing unit obtains a maximum speed value before a collision occurs and a maximum decibel value in the environmental sound data, and determines the collision severity of the mobile device based on the maximum speed value and the maximum decibel value.

11. The collision notification device according to claim 7, further comprising a storage unit, adapted to store a plurality of collision voiceprints, wherein the plurality of collision voiceprints respectively corresponds to a plurality of default collision objects, and the collision data processing unit obtains the plurality of collision voiceprints, and compares the environmental sound data with the plurality of collision voiceprints, to infer an actual collision object of the mobile device.

12. The collision notification device according to claim 11, wherein the collision data processing unit obtains a maximum decibel value in the environmental sound data, and determines the collision severity of the mobile device based on the acceleration data, the actual collision object, and the maximum decibel value.

13. The collision notification device according to claim 7, wherein the collision notification generation unit is adapted to generate a collision notification image presented on the display based on the collision severity.
